(19) United States
(12) Patent Application Publication
(10) Pub. No.: US 2014/0261202 A1
(43) Pub. Date: Sep. 18, 2014

(54) ELASTIC SLEEVE FOR ANIMAL FEEDING BOWL

(71) Applicant: Design Lab, Inc., Gardena, CA (US)

(72) Inventor: Lendy Beatty, Playa del Rey, CA (US)

(73) Assignee: Design Lab, Inc., Gardena, CA (US)

(21) Appl. No.: 14/274,845

(22) Filed: May 12, 2014

(51) Int. Cl. A01K 5/01

(52) U.S. Cl. CPC A01K 5/0135
USPC 119/61.54

(57) ABSTRACT

A sleeve that is removably attachable to an animal feeding bowl is shown and described. The sleeve is elastomeric and is stretched radially when in attached condition to fit snugly to the animal feeding bowl. The sleeve includes a flange at one end that projects radially inward to create an anti-skid surface that prevents the bowl from skidding along floors, counter tops, and other surfaces on which the bowl is placed.

### FIELD

This disclosure relates to elastic sleeves that are selectively attachable to animal feeding bowls.

### BACKGROUND

Animals, and in particular domestic pets, are typically fed from feeding bowls that sit on a floor or counter top. Typical known bowls are formed from stainless steel or ceramics. Ceramic bowls can readily be painted or drawn on to provide decorative features related to pets. However, they tend to be heavy and prone to breakage when dropped. In addition, any decorative features tend to be permanent can cannot be replaced by the pet owners without buying a new bowl.

Stainless steel bowls are more durable and will typically not break or suffer significant damage when dropped. However, other than by engraving, they are difficult to decorate in comparison to ceramic bowls and cannot typically be painted. Both ceramic and steel bowls are also prone to skidding when bumped by an animal or person, which can cause spills or damage to the bowl.

Certain animal feeding bowl assemblies have been proposed which include plastic outer shells that engage an inner bowl. The outer shells can be decorated, and can be separated from the inner bowl for cleaning or replacement. However, the outer shells are not elastic and do not snugly abut the outer surface of the inner bowl, which can result in the detachment of the shell from the bowl at undesired times. Such designs are also prone to trap food and liquids between the outer shell and the inner bowl. In addition, many plastics are themselves prone to skidding. As a result, in many known designs, an additional non-skid material or feature must be added to the plastic outer shell to reduce or eliminate skidding. Thus, a need has arisen for an elastic sleeve for an animal feeding bowl.

### BRIEF DESCRIPTION OF THE DRAWINGS

FIG. 1 is a side elevational view of a first animal feeding bowl assembly comprising a bowl and an elastic sleeve;

FIG. 2 is a perspective view of the elastic sleeve of FIG. 1 detached from the bowl;

FIG. 3 is a side elevational view of the elastic sleeve of FIG. 1 detached from the bowl;

FIG. 4 is a bottom plan view of the animal feeding bowl assembly of FIG. 1;

FIG. 5 is a side elevational view of the bowl of FIG. 1 with the elastic sleeve removed;

FIG. 6 is a side elevational view of a second animal feeding bowl assembly comprising a bowl and an elastic sleeve;

FIG. 7 is a perspective view of the elastic sleeve of FIG. 6 detached from the bowl;

FIG. 8 is a side elevational view of the elastic sleeve of FIG. 6 detached from the bowl;

FIG. 9 is a bottom plan view of the animal feeding bowl assembly of FIG. 6;

FIG. 10 is top plan view of the elastic sleeve of FIG. 6 detached from the bowl; and

FIG. 11 is a side elevational view of the bowl of FIG. 6 with the elastic sleeve removed.

### DETAILED DESCRIPTION

Described below are examples of elastic sleeves that are removably attachable to animal feeding bowls to form an animal feeding bowl assembly comprising a sleeved animal feeding bowl. In general, the elastic sleeves are sufficiently elastic such that they can be expanded to an expanded configuration and snugly installed on a bowl while still having sufficient structural integrity to retain a cylindrical sleeve shape when detached form the bowl and placed on a flat surface. The sleeves also have a tensile strength and tear strength sufficient to endure the repeated removal of the sleeve from the bowl and reinstallation of the sleeve on the bowl.

In certain preferred examples, the elastic sleeves include a bottom surface that is defined by a flange that projects in a radially inward direction at one end of the sleeve along the sleeve's height axis. The flange defines the bottom surface of the sleeve and an opening through which a portion of the bottom surface of the bowl is visible. In preferred examples, the sleeve is formed from a material with anti-skid properties, and the contact between the flange bottom surface and a surface on which the bowl rests (i.e., a floor or counter-top) creates a frictional resistance that reduces skidding. The opening defined by the flange allows engravings or other markings on the bottom of the bowl to be seen and reduces the amount of sleeve material required while still reducing skidding. When attached to the bowl, the sleeve extends along at least a portion of the bowl's height along the height axis starting from the end of the bowl's sidewall that is connected to the bowl's bottom.

Referring to FIG. 1, an animal feeding bowl assembly 20 is depicted. The animal feeding bowl assembly 20 is a sleeved animal feeding bowl comprising a bowl 22 and an elastic sleeve 24. The elastic sleeve 24 is removably attached to and snugly fits around the bowl 22 and extends along at least a portion of the height of the bowl 22 along the height axis h.

Referring to FIGS. 2-3, elastic sleeve 24 is shown removed from bowl 22 in a detached condition. As shown in the figure, when in the detached condition, the elastic sleeve 24 comprises a cylindrical side wall 26 that includes a top edge 28. Top edge 28 defines an opening that is perpendicular to the height axis h at the top of sleeve 24. Cylindrical side wall 26 includes an inner surface 42 and an outer surface 44 that are spaced apart by the radial axis r thickness of the elastic sleeve 24.

The cylindrical side wall 26 is attached to a flange 32 that projects away from the inner surface 42 of cylindrical side wall 26 inwardly along radial axis r. A transition region 30 that is generally curved outwardly along the radial axis r connects the cylindrical side wall 26 to the flange 32, as best seen in FIGS. 1 and 3.

Flange 32 includes an upward facing surface 36 and a downward facing surface 33 (FIG. 4), each of which are perpendicular to the height axis h. The downward facing surface 33 defines a bottom surface of elastic sleeve 24 that rests on a surface such as a floor or countertop. As FIGS. 2 and 3 indicate, in the detached state the elastic sleeve 24 has sufficient structural integrity to stand upright without any external support (other than the table, countertop, etc. on which the downward facing surface 33 rests). Thus, elastic sleeve 24 maintains the cylindrical sidewall 26 in a generally vertical orientation relative to the earth and in a generally perpendicular orientation relative to the flange 32 without any external support other than the surface on which the downward facing surface 33 of flanged 32 rests. In the example of FIGS. 2 and 3, the cylindrical sidewall 26 is not perfectly perpendicular to the surface on which the sleeve 24 rests or with respect to flange 32. Instead, the cylindrical side wall 26 flares outwardly along the radial axis r while moving along the height axis h in a direction away from the flange 32.

Referring to FIG. 4, in certain examples, the open area at the top of the sleeve 24 (i.e., the area of the opening perpendicular to height axis h which is defined by the diameter of the top edge 28 of the sleeve 24) is related to the area of the flange 32. The open area at the top of the sleeve (Aₜₒₚ) can be determined from the diameter of the top opening (D₃) as follows:

Aₜₒₚ=(π/4)(D₃)² (1)

As shown in FIG. 4, the area of the bottom surface 33 of the flange 32 perpendicular to the height axis h can be determined as follows:

A_{flange}=(π/4)[(D₁)²−(D₂)²] (2)

Thus, the ratio of the flange area to the open top area can be determined as follows:

A_{flange}/Aₜₒₚ=[(D₁)²−(D₂)²]/(D₃)² (3)

In equations (1)-(3), D₁ is the diameter of the bottom surface of the sleeve 24 defined by the radially outermost extent of flange bottom surface 33. D₂ is the diameter of the opening 35 defined by the radially inner edge 34 of the flange 32 (FIG. 2). The radial dimension of the flange r₁ may be determined as follows:

r₁=(D₁−D₂)/2 (4)

In certain preferred examples of the bowl assembly 20, the ratio of A_{flange} to Aₜₒₚ in accordance with equation (3) is less than about 0.5, more preferably, less than about 0.45, and still more preferably less than about 0.35. At the same time, the ratio of A_{flange} to Aₜₒₚ is preferably at least about 0.1, more preferably at least about 0.2, and still more preferably at least about 0.25. In addition, the sleeve top opening diameter D₃ and area are preferably greater than the sleeve bottom opening 35 diameter D₂ and its area, respectively.

As shown in FIG. 4, the portion of the bottom surface 54 of the bowl 22 that lies within the opening 35 (FIG. 2) is visible when the bowl assembly 20 is viewed in a bottom plan view. As compared to other designs in which the sleeve 24 has a continuous bottom without opening 35, the design of FIGS. 1-4 provides an anti-skid feature while reducing the amount of material required to form elastic sleeve 24. In addition, the design allows engravings or other markings on the bottom surface 54 of bowl 22 to be seen.

Sleeve 24 is elastic, i.e., it can be deformed by a deforming force and returns to its original shape upon release of the deforming force. In certain preferred examples, the sleeve 24 comprises an elastomeric material with a percent elongation (at rupture) under a tensile load of at least about 200 percent, preferably at least about 300 percent, more preferably at least about 400 percent, and still more preferably at least about 500 percent. Percentage elongation may be determined using procedures known to those skilled in the art such as ASTM D-412. In certain examples, sleeve 24 is formed entirely from an elastic material (not including any subsequently attached ornamental items such as studs, rhinestones, or the like). In other examples, sleeve 24 is formed entirely from an elastomeric material. In additional examples, sleeve 24 is formed from a single elastomeric material created by polymerizing and/or cross linking a precursor composition that includes one or more polymeric precursors that react to form the single elastomeric material. In a particularly preferred example, the precursor composition is polymerized and cross-linked while being molded to form the shape of the elastic sleeve 24.

In the same or other examples, the sleeve 24 has a tearing strength of at least about 15 kN/m, more preferably at least about 17 kN/m, still more preferably at least about 19 kN/m, and even more preferably at least about 20 kN/m. Tearing strength may be determined using procedures known to those skilled in the art such as ASTM D-624. At the same time or in other examples, sleeve 24 has a tensile strength that is preferably at least about 5 MPa, more preferably at least about 7 MPa, and still more preferably at least about 8 MPa. Tensile strength may be determined using procedures known to those skilled in the art such as ASTM D-412.

The resilience of the materials used to form sleeve 24 may also be characterized using a rebound percentage determined using procedures known to those skilled in the art such as ASTM D7121. Elastic sleeve 24 preferably has a rebound percentage of at least about 40 percent, more preferably at least about 45 percent, still more preferably at least about 50 percent, and even more preferably at least about 53 percent.

In the same or other examples, elastic sleeve 24 has a plasticity of no more than 220±15, preferably no more than 210±14, still more preferably no more than 200±15, and even more preferably no more than 190±15. At the same time, the plasticity of elastic sleeve 24 is preferably no less than 140±15, more preferably no less than 150±15 and still more preferably no more than 170±15. Plasticity may be measured using techniques known to those skilled in the art including those using a Williams Parallel Plate Plastimeter.

In preferred examples, elastic sleeve 24 is heat resistant. As used herein, the term “heat resistant” means that the elastic sleeve can withstand being subjected to a temperature of about 230° C. for about 1 hour without incurring visible damage or color change.

In the same or other examples, elastic sleeve 24 has a shore A hardness (within a tolerance of ±2) that is at least about 35, more preferably at least about 40, still more preferably at least about 45, and even more preferably at least about 48. At the same time, elastic sleeve 24 has a shore A hardness (within a tolerance of ±2) that is preferably no more than 70, more preferably no more than about 60, still more preferably no more than about 55, and still more preferably no more than about 52.

Preferred elastomeric materials for forming elastic sleeve 24 are those comprising silicone polymers. The elastomeric materials are preferably formed from a precursor composition comprising one or more siloxane precursors and a cross-linking agent. The cross-linking agent reacts with the precursors to form cross-linked polymer chains. Suitable cross-linking agents include free radical initiators, such as organic peroxide initiators. In one example, a DBPMH (2,5-dimethyl-2,5-di(tert-butylperoxy)hexane, free radical initiator is used. In the same or other examples, the one or more siloxane precursors include a first siloxane precursor with one or more unsaturated alkyl groups, preferably a single vinyl group, and a second siloxane precursor that includes no unsaturated alkyl groups. A particularly preferred siloxane having a vinyl group is vinylmethyl polysiloxane (CAS No. 68037-87-6) (also known as vinylmethylsiloxane homopolymer and poly (vinylmethylsiloxane)). A preferred second siloxane precursor is a polydimethylsiloxane precursor (CAS No. 63148-62-9) (also known as “silicone oil”). In certain examples, the precursor composition used to form the elastic sleeve 24 also comprises a silica (Sift) filler (CAS No. 112945-62-5).

In certain preferred examples, with the exception of subsequently applied surface ornamentation, sleeve 24 is a single elastomeric material that is integrally formed from a precursor composition that consists essentially of vinylmethyl polysiloxane (CAS No. 68037-87-6), silica (112945-62-5), and polydimethylsiloxane (CAS No. 63148-62-9). Before molding the composition, the precursor is combined with a free radical initiator, such as DBPMH.

Suitable precursor compositions may be prepared or obtained from commercial sources. In one example, a precursor composition supplied under the trade name ZY-4452 by DongGuan New Orient Technology is used. This precursor composition comprises 68-70 percent by weight of methyl vinyl polysiloxane (CAS No. 68037-87-6), 20-23 percent by weight silica (CAS No. 112945-52-6), and 4-12 percent by weight of polydimethyl siloxane (CAS No. 63148-62-9).

The precursor composition used to form the elastic sleeve is preferably prepared by combining the various precursor components and placing the resulting precursor composition into a mold having the shape of the elastic sleeve 24. Heat is then applied to initiate polymerization and cross-linking In certain preferred examples wherein the precursor composition includes first and second siloxane precursors of the type described above, a first, unsaturated alkyl-containing siloxane precursor is preferably present in an amount by weight of the total precursor composition which is no less than about 50 percent, more preferably no less than about 55 percent, still more preferably no less than about 60 percent, and even more preferably no less than about 65 percent. At the same time, the first unsaturated alkyl-containing siloxane precursor is preferably present in an amount by weight of the total precursor composition that is no more than about 85 percent, more preferably no more than about 80 percent, still more preferably no more than about 78 percent, and even more preferably no more than about 75 percent.

In accordance with such preferred examples using first and second siloxane precursors, the second siloxane precursor (which lacks unsaturated alkyl groups) is preferably present in an amount by weight of the total precursor composition that is at least about 1 percent, more preferably at least about 2 percent, and still more preferably at least about 3 percent. At the same time, the second siloxane precursor is preferably present in an amount by weight of the total precursor composition that is no more than about 20 percent, more preferably no more than about 18 percent, and still more preferably no more than about 15 percent.

In certain preferred examples, the precursor composition also includes a silica filler. The silica filler is preferably present in an amount by weight of the composition that is at least about 10 percent, more preferably at least about 15 percent, and still more preferably at least about 18 percent. At the same time, the silica filler is preferably present in an amount by weight of the composition that is no more than about 30 percent, more preferably no more than about 27 percent, and still more preferably no more than about 25 percent.

The initiator is preferably present in an amount by weight of the total precursor composition of at least about 0.6 parts by per 100 parts, more preferably at least about 0.8 parts per 100 parts, and still more preferably at least about 1.0 parts per 100 parts. At the same time, the initiator is preferably present in an amount by weight of the composition of no more than about 1.8 parts per 100 parts, more preferably no more than about 1.6 parts per 100 parts, and still more preferably no more than about 1.4 parts per 100 parts.

To form the elastic sleeve 24, the precursor composition used to form the sleeve is preferably combined with an initiator and subjected to a polymerization and cross-linking temperature ranging from about 170° C. to about 210° C., more preferably from about 175° C. to about 205° C., and still more preferably from about 180° C. to about 200° C. for a period ranging from about 1 minute to about 10 minutes, more preferably from about 1.5 minutes to about 4 minutes, and still more preferably from about 2.5 minutes to 3.5 minutes. At the same time, the precursor composition is preferably subjected to a pressure ranging from about 10 MPa to about 20 MPa, more preferably from about 12 MPa to about 18 MPa, and still more preferably from about 14 MPa to about 16 MPa. As indicated previously, in preferred examples, the polymerization and cross-linking is carried out contemporaneously with a molding process while the precursor composition is in a mold corresponding to the shape of the sleeve 24.

In certain examples of elastic sleeve 24, decorative features are provided. The decorative features may relate to animals including those to be fed using bowl 22. In certain examples, the decorative features comprise patterns defined by areas within cylindrical side wall 26 where the elastic material is not present. For example, in the elastic sleeve 24 of FIGS. 1-4, decorative patterns 38 and 46 are provided. Decorative patterns 38 and 46 comprise respective areas within elastic sleeve 24 where elastic material is absent, and thus, define patterned openings from the outer surface 44 to the inner surface 42 of cylindrical side wall 26. In the example of FIG. 1, the decorative patterns 38 and 46 are fish skeletons. Since many types of cat food include fish, the pattern is particularly tailored for use with cat feeding bowls. Because no elastic material is present in the area defined by decorative patterns 38 and 46, the outer surface of the cylindrical side wall 52 of the bowl (FIG. 5) is visible through the patterns 38 and 46 when the sleeve 24 is installed on the bowl 22, as shown in FIG. 1.

In preferred examples, the decorative patterns 38 and 46 are defined by the mold used to create the elastic sleeve 24. For example, the mold may be provided with protrusions in the shape of decorative patterns 38 which prevent any of the precursor composition used to form the elastic sleeve 24 from entering the area occupied by the protrusion.

Elastic sleeve 24 also includes a number of studs 40a-40d (others are shown but are not specifically identified with reference numerals). Although not visible in FIGS. 1-4, the outer surface 44 of cylindrical sleeve 26 includes molded in shapes that define recesses which correspond to the shape of the studs 40a-40d. After sleeve 24 is molded, the studs 40a-40d can be placed within their respective recesses and held in place by industrial glue. Other surface embellishments such as rhinestones may also be used.

In the example of FIGS. 1-4, the elastic sleeve 24 is held in place on bowl 22 by the elastic restoring force of the sleeve 24 material. When elastic sleeve 24 is in the detached condition (i.e., not installed on bowl 22) of FIG. 3, the sleeve 24 has a first, detached state diameter at the top sleeve edge 28. However, when the sleeve 24 is installed on bowl 22 as shown in FIGS. 1, the sleeve 24 has a second, attached state diameter at the top sleeve edge 28. The second, attached state diameter is greater than the detached state diameter. As a result, the elasticity of the sleeve 24 creates a restoring force directed along the radial axis r which causes the inner surface 42 of the cylindrical side wall 26 to exert a force against the outer surface of the bowl side wall 52 (FIG. 5). The exerted force will have a component that is perpendicular to the outer surface of the bowl side wall 52, thereby creating a frictional force that holds the sleeve 24 in place on the bowl 22. In general, when the sleeve 24 is installed on the bowl 22 as shown in FIG. 1, each cylindrical sidewall 26 location along the height axis h will have an attached state diameter that is greater than its corresponding detached state diameter. Thus, in certain preferred examples, the sleeve 24 snugly engages the outer surface of the bowl side wall 52 around substantially or all of the entirety of the side wall's circumference and along substantially or all of the entire height of sleeve 24 along the height axis h. As a result, the bowl assembly 20 requires no mechanical fasteners or connections to securely engage the sleeve 24 to the bowl 22, yet sleeve 24 remains removably attached to bowl 22.

As shown in FIG. 5, the bowl 22 comprising bowl assembly 20 is a standard, stainless steel bowl with a sidewall 52 that has a continuously smooth outer surface and a closed bottom 50. The bowl includes a top edge 48 on an outwardly projecting lip. The top edge 48 defines a circular opening perpendicular to height axis h. The bowl 22 does not include any designed-in features used to engage the sleeve 24. Instead, the elastic force exerted by the sleeve 24 against the bowl 22 is sufficient to hold the sleeve 24 securely in place. Correspondingly, the inner surface 42 of the sleeve cylindrical side wall 26 and the upward facing surface 36 of the sleeve flange 32 are smooth and do not include any designed-in surface features to secure the sleeve 24 to the bowl 22.

In certain preferred examples, bowl 22 is formed from stainless steel and is dishwasher safe. Unlike many ceramics, stainless steel is typically dishwasher safe. Thus, in certain preferred examples, the bowl assembly 20 of FIGS. 1-5 provides a decorative bowl assembly with a bowl that can be cleaned in a dishwasher by removing the sleeve 24. At the same time, the inner surface 42 of the sleeve side wall 26 and the upward facing surface 36 of the flange 32 are less likely to become dirty or fouled by water or food because of their close fitting engagement to the bowl 22. In certain examples, wherein sleeve 24 does not include rhinestones or other surface embellishments, the sleeve 24 is also dishwasher safe. In addition, the sleeve 24 can be replaced as desired to provide a bowl assembly with different decorative designs using the same bowl 22.

Referring to FIGS. 6-11, another example of an animal feeding bowl assembly comprising a sleeved animal feeding bowl is depicted. Animal feeding bowl assembly 60 comprises a bowl 62 and an elastic sleeve 64. Suitable and preferred materials for forming elastic sleeve 64 are the same as those described previously for elastic sleeve 24 in the example of FIGS. 1-5. Elastic sleeve 64 comprises a cylindrical side wall 66, a top edge 68, and a flange 72 (FIG. 7). A lip 69 is provided at the top of the cylindrical sidewall and projects outwardly along the radial axis r. The top edge 68 of the elastic sleeve 64 is defined on the top of the lip 69. Cylindrical side wall 66 includes a radially inner surface 82 and a radially outer surface 84 that are spaced apart by the thickness of the sleeve 64 along the radial axis r. Flange 72 projects away from sidewall inner surface 82 along radial axis r.

As best seen in FIGS. 9 and 10, the flange 72 includes a surface 76 that faces upward perpendicularly to the height axis h and a surface 73 that faces downward perpendicularly to the height axis h. When sleeve 64 is installed on bowl 62, a portion of the bottom surface 94 of bowl 62 snugly abuts the upward facing surface 76 of the flange 72. The downward facing surface 73 of flange 72 rests on whatever surface the bowl assembly 60 is placed on, such as a floor or countertop. The downward facing surface 73 of the flange 72 acts as an anti-skid surface by providing a coefficient of friction with typical floor and counter surfaces that his higher than the coefficient of friction between those surfaces and the bottom surface 94 of the bowl 62, which is preferably stainless steel.

Flange 72 includes a radially inner edge 74 that defines an opening 75 at the bottom of the sleeve 64. The opening 75 is spaced apart from the opening defined by the top sleeve edge 68 along the height axis h. Opening 75 preferably has a diameter less than that of the sleeve top opening defined by top edge 68. As shown in FIG. 9, a portion of the bottom surface 94 of the bowl 62 is visible through the sleeve bottom opening 75, allowing engravings or other markings on the bowl bottom surface 94 to be seen when the bowl assembly 60 is viewed in a bottom plan view. As with the example of FIGS. 1-5, in certain examples, the flange 72 has an area perpendicular to the height axis h that is related to the area defined by the opening within the top edge 68 of the sleeve 64. Diameters D1 to D3 may be defined for sleeve 64 in the same manner as for sleeve 24, and equations (1)-(3) may be used to determine the ratio of the flange area A_{flange} to the top opening Aₜₒₚ. The ratio has the same preferred and more preferred values described previously for the example of FIGS. 1-5.

Sleeve 64 also has a number of decorative features 78a-78j. The decorative features 78a-78j comprise patterns where elastic material is absent. In the example of FIGS. 6-11, the patterns 78a-78j comprise a plurality of dog bone patterns spaced around the circumference of the sleeve 64. The decorative patterns can be provided as described previously with respect to FIGS. 1-5. However, in the example of FIGS. 6-11, no surface ornamentation, such as studs or rhinestones, is provided. As a result, sleeve 64 is dishwasher safe and can be safely washed with bowl 62 in a dishwasher owing to the high temperature resistance of the elastic material used to form sleeve 64, examples of which are described previously with respect to the sleeve 24 of FIGS. 1-5.

Referring to FIG. 11, bowl 62 includes a top edge 88 that defines a top opening perpendicular to height axis h, a cylindrical sidewall 92, and a closed bottom 90. The closed bottom 90 includes an upward facing surface (not shown) and a downward facing surface 94 perpendicular to the height axis h. A portion of downward facing surface 94 is shown in FIG. 9. Bowl 62 also includes a lip 89 that projects outwardly along the radial axis r on which the top edge 88 is located The top edge 88 and the closed bottom 90 are spaced apart from one another along the height axis h. In the example of FIG. 11, bowl 62 is formed from stainless steel that is dishwasher safe.

The sleeve 64 of FIGS. 6-11 is tailored for use with larger animal feeding bowls than those for which sleeve 25 of FIGS. 1-5 is intended. In some cases with larger feeding bowls, it may be desirable to include to include additional molded in features in the sleeve 64 to enhance the engagement of the sleeve 64 to the bowl 62. Referring to FIGS. 7 and 10, sleeve 64 includes a lip 77 that projects inwardly along the radial axis r. The lip 77 engages a complementary groove 91 formed in outer surface of the cylindrical side wall 92 of the bowl 62. In the example of FIGS. 6-11, the lip 77 is positioned between flange 72 and the top sidewall edge 68 along the height axis h and is closer to the flange 72 than to the top edge 68. In particular, the lip 77 is located between the height axis midpoint of cylindrical sidewall 66 and flange 72. The bowl groove 91 is similarly positioned between the height axis midpoint of bowl sidewall 92 and the closed bottom 90 of the bowl 62. Because the lip 77 projects into the groove 91, the lip 77 is restrained from moving along the height axis h. Thus, in addition to the frictional force of the elastic material that engages the sleeve 64 to the bowl 62 in a manner similar to the sleeve 24 and the bowl 22 of FIGS. 1-5, the engagement of the lip 77 and groove 91 provides a further mechanical means of engagement, albeit one that does not require any sort of external fasteners or means of attachment other than that provided by the bowl 62 and sleeve 64 themselves. When the sleeve 64 is installed on the bowl 62 as shown in FIG. 6, the inner surface 82 of the sleeve 64 snugly abuts the outer surface of the bowl sidewall 92 around substantially the entirety or the entirety of the circumference of the bowl 62 and along substantially the entirety or the entirety of the height of the sleeve 64 along the height axis h, and the lip 77 snugly abuts the portion of the bowl 62 lying within groove 91.

### EXAMPLE

A silicone elastic sleeve precursor composition ZY-4452 supplied by DongGuan New Orient Technology is provided and is placed into a mold corresponding to the shape of sleeve 24 of FIGS. 1-4. Before molding, the precursor composition has a relative density at 25° C. of 1.16. The precursor composition comprises 68-70 percent by weight of methyl vinyl polysiloxane (CAS No. 68037-87-6), 20-23 percent by weight silica (CAS No. 112945-52-5), and 4-12 percent by weight polydimethylsiloxane (CAS No. 63148-62-9). The precursor composition is combined in the mold with 0.012 percent by weight (based on the total composition) of a DBPMH (2,5-dimethyl-2,5-di(tert-butylperoxy)hexane) free radical initiator. The mold is closed and heated to a temperature of 180° C. at a pressure of 15 MPa for 3 minutes. The resulting elastic sleeve has a height of 1.25 inches (32 mm) along the height axis h and a thickness of 2 mm along the radial axis r. The sleeve has a Shore A Hardness of about 50 with a measurement error of ±2 units, a tensile strength of at least about 8 MPa, a percent elongation of at least about 500, a tear strength of at least about 20 kN/m, a tensile permanent deformation of about 8 percent, and a percent resilience of at least about 45 percent. The resulting elastic sleeve 24 is a single elastomeric material formed from a precursor composition that consists of methyl vinyl polysiloxane (CAS No. 68037-87-6), silica (CAS No. 112945-52-5), polydimethylsiloxane (CAS No. 63148-62-9), and a free radical initiator. The mold includes protrusions that define shallow recesses in the outer surface of the sleeve, and following molding, the sleeve is then adorned with studs 40a-40d by affixing them into respective recesses with industrial glue.

The sleeve 24 has a top opening diameter D₃ defined by top edge 28 of 4.25 inches (108 mm), a bottom diameter (D₁) of 3.5 inches (89 mm), and a bottom opening diameter (D₂) of 2.5 inches (64 mm). The sleeve 24 is stretched along the radial axis and installed on bowl 22 so that the inner surface 42 of the sleeve 24 snugly abuts the cylindrical side wall 52 of the bowl 22 along the entire height and circumference of the sleeve 24 and so that the upward facing surface 36 of the flange 32 snugly abuts a portion of the bottom surface 54 of the closed bottom 50 of bowl 22. The ratio of the area of the flange A_{flange} to the area of the top opening Aₜₒₚ as determined using equation (3) and is 0.33. Animal food is periodically placed in the bowl 22. At periodic intervals, sleeve 24 is removed from bowl 22 and the bowl 22 is cleaned in a dishwasher. Sleeve 24 is heat resistant and can withstand exposure to a temperature of 230° C. for 1 hour without experiencing visible damage or a visible change in color. At other periodic intervals, sleeve 24 is replaced by a similarly dimensioned sleeve with decorative features different from those on sleeve 24.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An animal feeding bowl sleeve, comprising:
a cylindrical side wall, wherein the cylindrical sidewall has a height axis and a radial axis; and
a flange projecting inwardly along the radial axis, wherein the cylindrical sidewall defines a top opening spaced apart from the flange along the height axis, and the flange defines a bottom surface and a bottom opening inward of the bottom surface along the radial axis.

2. The animal feeding bowl sleeve of claim 1, wherein the sleeve comprises an elastic material.

3. The animal feeding bowl sleeve of claim 2, wherein the sleeve is formed entirely from an elastic material.

4. The animal feeding bowl sleeve of claim 2, wherein the elastic material is a silicone elastomer material.

5. The animal feeding bowl sleeve of claim 3, wherein the silicone elastomer material is formed a precursor composition comprising methyl vinyl polysiloxane.

6. The animal feeding bowl sleeve of claim 1, wherein the sleeve has a percent elongation of at least about 200 percent.

7. The animal feeding bowl sleeve of claim 1, wherein the sleeve has a tear strength of at least about 15 kN/m.

8. The animal feeding bowl sleeve of claim 1, wherein the sleeve has a tensile strength of at least about 5 MPa.

9. The animal feeding bowl sleeve of claim 1, wherein the top opening has an area, the bottom opening has an area, and the top opening area is greater than the bottom opening area.

10. The animal feeding bowl sleeve of claim 1, wherein the top opening has a first area, the flange has a second area, and the ratio of the second area to the first area is less than about 0.5.

11. The animal feeding bowl sleeve of claim 1, further comprising a plurality of openings through the cylindrical wall, wherein the openings define decorative shapes.

12. The animal feeding bowl sleeve of claim 1, wherein the cylindrical sidewall has an inner surface, an outer surface, and a lip formed on the inner surface and projecting inwardly along the radial axis.

13. A sleeved animal feeding bowl, comprising:
the animal feeding bowl sleeve of claim 1; and
an animal feeding bowl having an inner surface, an outer surface, a bottom, and a height, wherein the animal feeding bowl sleeve is removably attached to the animal feeding bowl such that the inner surface of the sleeve cylindrical wall snugly abuts the outer surface of the animal feeding bowl.

14. The sleeved animal feeding bowl of claim 13, wherein the top opening of the sleeve has a first diameter in a detached state and a second diameter in an attached state in which the sleeve is attached to the animal feeding bowl, and the second diameter is greater than the first diameter.

15. The sleeved animal feeding bowl of claim 13, wherein the flange further includes an upward facing surface opposite the bottom surface of the sleeve, and the bottom of the animal feeding bowl snugly abuts the upward facing surface of the flange.

16. The sleeved animal feeding bowl of claim 13, wherein the bottom surface of the flange defines an anti-skid surface.

17. An animal feeding bowl sleeve, comprising:
an elastic sleeve that is selectively attachable to an animal feeding bowl, wherein when the elastic sleeve is detached from the animal feeding bowl, the elastic sleeve has a cylindrical wall having a height axis, a top opening, and a bottom opening spaced apart from the top opening along the height axis, the top opening defines a first area, the bottom opening defines a second area, and the first area is greater than the second area, and the elastic sleeve is formed from an elastomeric material having a percent elongation of at least about 200 percent.

18. The animal feeding bowl sleeve of claim 17, wherein the elastic sleeve is formed exclusively from the elastomeric material.

19. The animal feeding bowl sleeve of claim 18, wherein the elastomeric material comprises a silicone polymer.

20. The animal feeding bowl sleeve of claim 18, wherein the elastomeric material is formed from a precursor composition comprising methyl vinyl polysiloxane.

21. The animal feeding bowl sleeve of claim 18, wherein the elastomeric material is formed exclusively from a precursor composition consisting essentially of methyl vinyl polysiloxane, silica, and polydimethylsiloxane.

22. The animal feeding bowl sleeve of claim 17, wherein the elastomeric material has a tear strength of at least about 15 kN/m.

23. The animal feeding bowl sleeve of claim 17, wherein the cylindrical wall has a radial axis, the elastic sleeve has a flange projecting inwardly along the radial axis, the flange is spaced apart from the top opening of the cylindrical wall, and the flange defines the bottom opening of the elastic sleeve.

24. A sleeved animal feeding bowl, comprising:
the animal feeding bowl sleeve of claim 17; and
an animal feeding bowl having an inner surface, an outer surface, a closed bottom, and a height, wherein the animal feeding bowl sleeve is removably attached to the animal feeding bowl such that the inner surface of the cylindrical wall snugly abuts the outer surface of the animal feeding bowl along substantially the entire height of the sleeve.

25. The sleeved animal feeding bowl of claim 24, wherein the top opening of the sleeve has a first diameter in a detached state and a second diameter in an attached state wherein the sleeve is attached to the animal feeding bowl, and the second diameter is greater than the first diameter.

26. A sleeved animal feeding bowl, comprising:
a bowl having an open top, a closed bottom, and a cylindrical side wall having a height along a height axis;
a sleeve having a cylindrical side wall, and open top, and an open bottom, wherein the sleeve cylindrical sidewall has an outer surface and an inner surface, the sleeve cylindrical sidewall has a height along the bowl height axis, the sleeve is removably attached to the bowl such that the inner surface of the sleeve cylindrical sidewall snugly abuts the outer surface of the bowl cylindrical side wall along substantially the entire height of the sleeve, the sleeve open top has a first diameter when the sleeve is detached from the bowl and a second diameter when the sleeve is removably attached to the bowl, and the second diameter is greater than the first diameter.

27. The sleeved animal feeding bowl of claim 26, wherein the sleeve comprises an elastic material.

28. The sleeved animal feeding bowl of claim 27, wherein the elastic material is an elastomeric material having a percent elongation of at least about 200 percent.

29. The sleeved animal feeding bowl of claim 28, wherein the elastomeric material includes a silicone polymer.

30. The sleeved animal feeding bowl of claim 28, wherein the elastomeric material is formed from a precursor composition comprising vinyl methyl polysiloxane.

31. The sleeved animal feeding bowl of claim 28, wherein the precursor composition consists essentially of vinyl methyl polysiloxane, polydimethylsiloxane, and a free radical initiator.

32. The sleeved animal feeding bowl of claim 30, wherein the precursor composition further comprises silica.

33. The sleeved animal feeding bowl of claim 28, wherein the elastomeric material has a tear strength of at least about 15 kN/m.

34. The sleeved animal feeding bowl of claim 26, wherein the bowl has a radial axis, the sleeve further comprises a flange projecting inwardly along the radial axis, the flange has an upward facing surface that snugly abuts the bottom of the bowl, and a downward facing surface, and a portion of the bottom of the bowl located inward of the flange along the radial axis is visible when viewing the bottom surface of the flange in a direction perpendicular to the bottom surface of the flange.

35. The sleeved animal feeding bowl of claim 26, wherein when the sleeve is removably attached to the bowl, the sleeve open bottom has a third diameter, and the second diameter is greater than the third diameter.
